(19) United States
(12) Patent Application Publication
(10) Pub. No.: US 2014/0299654 A1
(43) Pub. Date: Oct. 9, 2014

(54) SETUP FOR ASSEMBLING A PANEL BY BRAZING

(71) Applicants: AIRCELLE, GONFREVILLE L'ORCHER (FR); SNECMA PROPULSION SOLIDE, LE HAILLAN (FR)

(72) Inventors: Hélène MALOT, Sainte Adresse (FR); Philippe Bienvenu, Rogerville (FR); Frédéric Guichard, St Medard-en-Jalles (FR); Olivier Drevet, Le Taillan Medoc (FR)

(73) Assignees: AIRCELLE, GONFREVILLE L'ORCHER (FR); SNECMA PROPULSION SOLIDE, LE HAILLAN (FR)

(21) Appl. No.: 14/274,926

(22) Filed: May 12, 2014

Related U.S. Application Data
(63) Continuation of application No. PCT/FR2012/052583, filed on Nov. 9, 2012.

(30) Foreign Application Priority Data
Nov. 10, 2011 (FR) 11/60277

(51) Int. Cl. B23K 31/02; B23K 37/00

(52) U.S. Cl. CPC B23K 31/02; B23K 37/00
USPC 228/173.1; 228/15.1

(57) ABSTRACT

A setup for assembling, by brazing, a composite panel including at least two parts separated by a filler material and joined together by brazing. The setup includes a furnace to achieve a brazing temperature for brazing the panel, and an assembly device which has a form having a shape similar to the final shape of the panel to be brazed. In particular, the assembly device further includes a pressing device to apply mechanical pressure to at least part of the surface of the panel in a direction allowing the panel to be permanently deformed into a shape which matches that of the form. The pressing device is moved under the action of a spring, and the forces applied by the spring being determined so that, at the brazing temperature, the spring applies the force necessary for deforming the panel against the form.

### CROSS-REFERENCE TO RELATED APPLICATIONS

This application is a continuation of International Application No. PCT/FR2012/052583, filed on Nov. 9, 2012, which claims the benefit of FR 11/60277, filed on Nov. 10, 2011. The disclosures of the above applications are incorporated herein by reference.

### FIELD

The present disclosure relates to the manufacture of cellular core panels, and more particularly, to a device allowing the implementation of a method for brazing such panels.

### BACKGROUND

The statements in this section merely provide background information related to the present disclosure and may not constitute prior art.

The use of acoustic attenuation panels, for example in the nacelles of aircraft engines and nacelle elements equipped with such a panel to reduce noise emissions of turbojet engines, is known from the prior art.

In the case of an exhaust cone (plug), these acoustic attenuation panels generally have a sandwich structure comprising:
a perforated skin which is permeable to air, external (oriented towards the noise source), called “resistive” or “acoustic” skin, the role of which is to dissipate the acoustic energy,
a cellular core structure of the honeycomb type and,
an inner skin formed by a solid skin (opposite to the noise source), called structuring skin.

In some cases, the acoustic attenuation panels are designed to be installed in a hot area of the nacelle of the aircraft turbojet engine, and particularly in the downstream part of this nacelle through which exhaust gases are expelled.

The use of acoustic attenuation panels in this exhaust area allows for significantly reducing the sound emissions situated in the range of high frequencies.

For these particular applications at high temperature, acoustic attenuation panels whereof the outer skin is formed by a perforated metal sheet are generally used, the cellular core structure is metallic, and the inner skin is a solid metal sheet.

The cellular core structure can then be joined by brazing the solid metal sheet and the perforated metal sheet.

By definition, brazing is a method for assembling two elements using a filler metal having a melting temperature lower than that of the base metal of the elements. By bringing the filler metal to its melting temperature, the filler metal melts and wets the base metal with which it is in contact and then diffuses within the latter. Then, by cooling the assembly, the filler metal solidifies and provides bonding between the different elements in contact.

Such assembling operations of acoustic attenuation panels are delicate operations insofar as there is a risk that the acoustic and structural qualities of the panel are affected by these operations such as affecting the mechanical strength of the panel or even a loss of panel acoustic absorption.

A bad relative positioning of the constitutive elements of the panel after brazing can have an impact on the acoustic and structural qualities of the panel.

It is thus desirable to be able to best control the relative positioning of the pieces involved during brazing and the braze joint, namely the contact between the brazed elements.

Moreover, the assembling operations can affect metallurgical properties of the treated panel and have an impact on the surface properties of the latter, which can reduce the aerodynamic performances thereof.

Devices for assembling pieces to be brazed, in which stress forces are exerted on the pieces to be brazed in order to provide a sufficient contact pressure between the pieces and compensate for the expansions of the latter, are already known.

These forces tend to avoid deformations of pieces during brazing and to maintain them in their relative shape and positioning.

These deformations, if not controlled, generate brazing defects such as a poor quality of the braze joints or a local lack of the joint.

A known device provides for the use of tie rods to apply a mechanical pressure on the elements to be brazed, during brazing. The mechanical pressure may be insufficient during the brazing cycle, particularly during melting of the filler material. The defects of the braze joint may persist.

Another known device can provide for using means providing a gas pressure on the elements to be brazed, a more easily adjustable pressure to compensate for a decrease in the pressure applied on the pieces and prevent deformations and defects of the braze joints.

Moreover, such a device can further be used to stretch a piece if necessary while it is brazed, such as, for example, bending it such that it takes the shape of a matrix.

However, such devices face sealing problems that affect the quality of the pressure during brazing, and the properties of the braze joints that result from the brazing cycle.

Moreover, these problems multiply the maintenances of devices and the associated costs.

Furthermore, a risk of telegraphing is encountered, which is a phenomenon wherein, under gas pressure, an acoustic panel skin, for example, would be unintentionally deformed upon its installation on the device.

### SUMMARY

The present disclosure provides an assembly device by brazing of a composite panel comprising at least two parts separated by a filler material and intended to be joined together by a braze joint characterized in that it comprises:

a furnace allowing to reach a temperature for brazing the panel,

an assembly device comprising a form having a shape similar to the final shape of the panel to be brazed,

pressing means designed to exert a mechanical pressure on at least part of the surface of said panel along a direction allowing to permanently deform the panel into a shape, the configuration of which complies with that of a form,

these pressing means being designed to move under the action of elastic forcing means, the forces exerted by said elastic forcing means being determined so that, at the brazing temperature, they exert the forces necessary for deforming the panel against the form.

Thanks to the present disclosure, there is provided a mechanical assembly device by brazing a panel, easy to implement, which allows for controlling the thermal deformations and expansions of the elements constituting the panel and the braze joint.

Indeed, such a mechanical device allows to control the stress forces exerted on the panel in order to, on the one hand, provide a proper relative position of the different parts to be brazed, in spite of their respective expansions, throughout brazing, providing therefore a good quality braze joint while allowing to perform, during these expansions, a controlled deformation of the panel into a predetermined final shape.

According to particular forms of the present disclosure, a device according to the present disclosure can comprise one or several of the following technically feasible features, taken separately or in combination.

Advantageously, the forces exerted by said elastic forcing means are determined so that, throughout the thermal cycle, they exert the forces necessary to the deformation of the panel against the form.

Advantageously, the pressing means are movably mounted in translation on a support structure by means of a sliding connection.

In one form, such pressing means comprise at least one ring formed of a plurality of bearing pads distributed over the surface of the panel on which a mechanical pressure is exerted.

In another form, the pressing means are provided with at least one travel stop.

Advantageously, the pressing means are indexed on the support structure.

In one form, the elastic forcing means comprise leaf springs and/or springs.

Advantageously, the mechanical pressure exerted by each pressing means is defined independently from the other pressing means.

In another form, the elastic forcing means are each associated to a locking system defining the tensioning of elastic forcing means.

As one form, the locking system comprises a wedge system.

In still another form, the elastic forcing means are designed to become deformed in the direction of the slide.

In one form according to the present disclosure, the device is made of carbon-carbon material—and in one form is the Sepcarb® brand material, which allows to overcome the effects of flow and deformations generated by the thermal cycles of brazing.

In one form, the panel is a metal sandwich panel.

As another form, the panel is a sandwich panel of a cellular core structure.

The present disclosure also relates to an assembly method by brazing of a composite panel comprising at least two parts separated by a filler material and intended to be joined together by a braze joint implemented by the setup according to the present disclosure wherein:

the panel is docked on the tooling device;

the assembly device is placed in the heating means allowing to achieve a brazing temperature of the panel,

during the thermal cycle and at the brazing temperature, a pressure is exerted by the pressing means on at least part of the surface of said panel in a direction allowing to permanently deform the panel into a shape whereof the configuration conforms to that of the form, these pressing means being designed to move under the action of elastic forcing means, the forces exerted by said elastic forcing means being determined so that, at the brazing temperature, they exert the necessary forces for the deformation of the panel against the form.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic vertical cross-sectional representation of an assembly device by brazing of an acoustic panel according to the present disclosure, in a position in which the panel is brazed and deformed against a form; and

FIG. 2 is a schematic cross-sectional representation of the assembly device by brazing of an acoustic panel of FIG. 1, seen from above.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

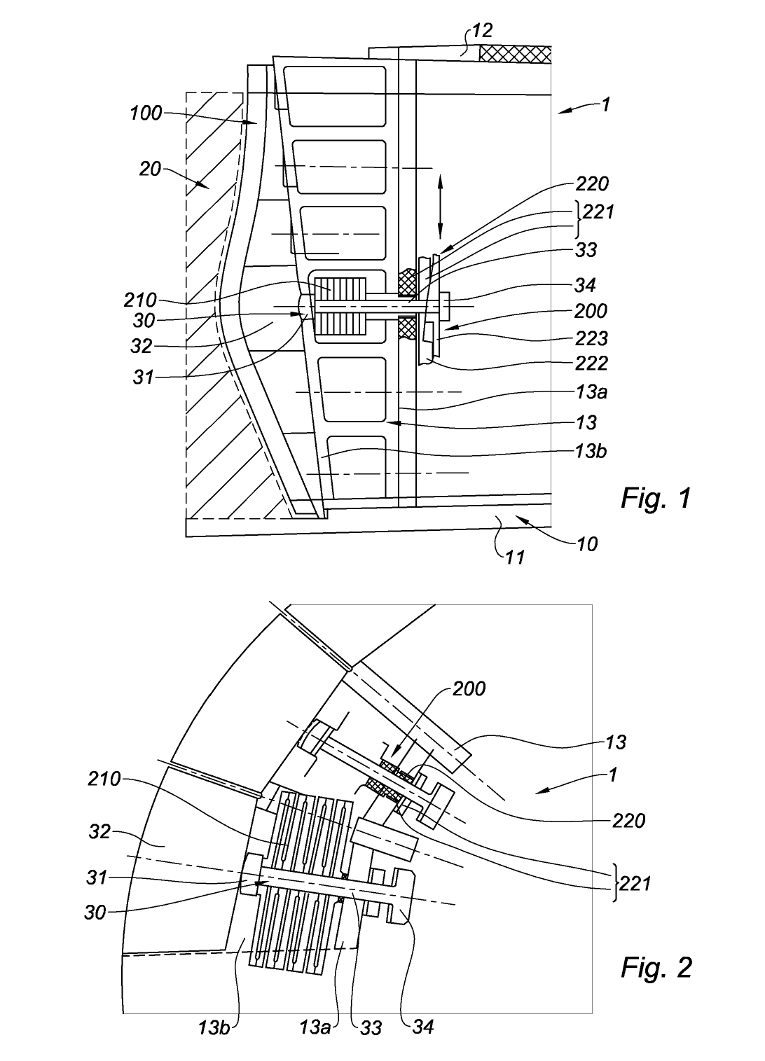

FIG. 1 schematically illustrates an assembly device 1 in accordance with the present disclosure for the implementation of a method of brazing.

Such a device 1 is arranged inside a brazing furnace, not shown.

The following examples will be described with respect to an operator requiring to assemble by brazing an acoustic attenuation panel 100.

The present disclosure is obviously neither limited to this field of application nor to the types of associated materials.

An acoustic attenuation panel, designated by the reference 100 on FIG. 1, includes, on the opposite side to the origin of the acoustic excitement, an inner skin consisting of a structuring skin formed in a sheet.

On this structuring skin, a structure of acoustic absorption material is brought, which, in a non-limiting manner, is a structure of honeycomb type.

An external acoustic skin formed, in a non-limiting manner by a perforated sheet can be brought onto the honeycomb structure.

This acoustic attenuation panel 100 is designed to be used in high temperature areas, in particular on an aircraft nacelle (in particular the area of expulsion of turbojet exhaust gas).

Thus, the structuring skin and the acoustic skin may be formed from metallic materials.

These materials can be selected from metals and/or metal alloys such as titanium, Inconel and all their grades.

The cellular structure may be formed, for its part, of metallic, polymer, ceramic or composite materials, available on the market.

The cellular structure can be fixed on the acoustic skin and on the inner skin by a brazing method, with an assembly device according to the present disclosure.

For this, a filler material interposed between the sheets and the cellular core structure is provided. It can be formed by a strip of braze joint or any other filler material of brazing, such as for example, a powder.

The melting point of this filler material should be lower than the melting temperature of the base metal of the skins and of the acoustic structure.

The device is designed to apply to this panel 100, during brazing, forces which tend to permanently deform from an initial shape of preform to a final shape after brazing.

More particularly, according to the present disclosure, the device 1 comprises pressing means 30 designed to exert mechanical pressure on at least part of the surface of said panel 100 in a direction allowing to permanently deform the panel 100 into a shape the configuration of which conforms to that of a form 20 during brazing.

These pressing means 30 are designed to move under the action of elastic forcing means 210, the forces exerted by said elastic forcing means 210 being determined so that throughout the assembly (of the brazing cycle(s) in particular), and more particularly at brazing temperature, they exert the necessary forces to the deformation of the panel 100 against the form 20.

More specifically, with reference to FIGS. 1 and 2, the assembly device 1 includes a frame 10 having a basic base 11 and a lid 12, the base 11 and the lid 12 being connected by a support structure 13.

This support structure 13 perpendicular to the base 11 and to the lid 12 is exhibited, according to a non-limiting example a conical framework with a double wall 13a, 13b.

The base 11 and the lid 12 are designed to allow a docking of the panel 100 to be brazed using clamping means (not shown).

These clamping means may include, but are not limited to, clamping screws.

The device 1 further comprises several deformation units 200 of the treated panel, in one example by the number of 96, designed to apply forces to the treated panel 100, still in the preform phase, during brazing, which tend to deform the panel 100 against the form 20 thus, so that the panel 100 espouses the mark of said form 20.

The number 96 of units is given for illustrative purposes and is in no way limiting.

Each unit 200 is implemented within the brazing furnace facing the form 20 the shape and dimensions of which are complementary to the final shape of the brazed panel 100.

This form 20 is a rigid external shell, stationary, integral with the frame 10 and, more particularly, the base 11

In one form, it consists of two upper and lower parts, this in order to facilitate the unmolding of the panel 100 at the end of the brazing cycle(s).

Each deformation unit 200 is mounted permanently on the support structure 13 in order to cooperate with the pressing means 30, themselves indexed, in part, by suitable means on the support structure 13.

This support structure 13 is associated, along the panel 100 to be brazed, to one or several superposed rings, each provided with several pressing means 30 providing forces that tend to apply the panel against the form 20.

These pressing means 30 may be distributed over the surface of the panel 100 on which each pressing means 30 exerts a local mechanical pressure.

Specifically, each pressing means 30 comprises at least one pressing sector 32 designed to contact the panel 100, this pressing sector 32 being slidably mounted relatively to the support structure 13 by means of a sliding connection.

Each pressing means 30 can move to apply a pressure to the panel 100 to be brazed, this movement being defined as cited above, by the elastic forcing means 210 to which they are associated.

Each of these is associated with end-of-travel stops limiting their movement and that, as a result, of the panel 100 to be brazed.

Thus, in one form mode of the present disclosure, illustrated in FIGS. 1 and 2, the rings of the pressing sector 32 are superposed by a suitable system, for example of a basket type, along the panel 100 and independently from the conical framework 13.

The pressing means 30 may come in the form of a pad 32 driven by a retainer rod 33 provided at its end opposite to the pad 32, with a supporting head 31, in simple contact on the corresponding pad 32 and, at the opposite end, a head forming an end-of-travel stop 34 of the rod 33.

This retainer rod 33 is mounted permanently in the support structure 13 crossing both walls 13a, 13b.

As for the heads forming end-of-travel stop 34, they allow to prevent any exit of the retainer rod 33 from its housing in the support structure 13.

They further participate in the locking/unlocking of the corresponding pressing means 30, as will be described later in the description.

In one form, the pressing means 30 have an axial stroke, radially with respect to the support structure 13, of the order of 3 mm in radius.

It is also to be considered to vary the stroke in an interval of 3 to 10 mm in radius.

Pertaining to the units of deformation 200, they include thrust systems of the pressing means 30 of the panel 100, namely the elastic forcing means 210 but also the locking means 220 providing the tensioning of the elastic forcing means 210 and used to support the latter.

The elastic forcing means 210 are fixed on the support structure 13 and more particularly, each in a particular concavity formed between the double wall 13a, 13b by a suitable maintenance system.

It may be mentioned, as non-limiting example of maintenance system, a ring providing the maintenance of the corresponding elastic forcing means 210 in the framework 13.

Furthermore, each elastic forcing means 210 is mounted on the circumference of the retainer rod 33 of the corresponding pressing means 30, between the supporting head 31 and the locking means 220.

The elastic forcing means 210 may come in a non-limiting manner, in the form of a leaf spring or a spring.

The locking means 220 are also supported by this support structure 13 and arranged in the axis of the sliding connection, opposite the corresponding support pad 32, between the elastic forcing means 210 and the head forming an end-of-travel stop 34 of the retainer rod 33.

The locking means or tapered wedges 220 as will be seen below allow the withdrawal of elastic forcing means 210 so as to provide the placing of the cone of the support structure 13.

The tapered wedges 220 are removed after locking the expansion plug on the frame 13 so that the elastic forcing means 210 exert a force on each pad 32, throughout the assembly and the thermal cycle of the panel 100 and particularly at brazing temperature.

This force is such that it provides the maintenance of the relative position of the constitutive elements of the panel 100 during their dilatation, while directing the deformation of the panel 100 so that it espouses the shape of the form 20, resulting in a plastic deformation of the panel 100 into its final shape.

Experiments, tests, routines, or calculations allow finding the calibration of the elastic forcing means 210, compared with their relative position on the panel 100 to be heat conformed.

More particularly, each elastic forcing means 210 is compressed to exert on the corresponding pressing means 30 a force in the direction of the slide, causing a radial displacement of the pressing means 30 which exert as such a compression force perpendicular to the panel surface 100 on the latter.

In one form, these locking or withdrawal means 220 include wedge systems 221, each of which defining the clamping force by biasing the corresponding elastic forcing means 210.

As illustrated in FIG. 1, in an alternative form, each wedge system 221 comprises two complementary beveled corner sections 222, 223, mounted between the inner side (opposite the elastic forcing means 210) of the inner wall 13a of the support structure 13 and the stop 34 of the retainer rod 33, on the circumference of the latter.

The relative movement of these two corner sections 222, 223 along the inner side of the inner wall 13a of the support structure 13 defines the associated movement of the retainer rod 33.

Any other known withdrawal system 220 may be provided.

During the temperature rise, the skins/sheets and the cellular core structure of the panel 100 are subjected to expansion forces and their relative position may change as they tend to become spaced apart from each other.

The device 1 according to the present disclosure allows to apply evenly distributed forces of adapted intensity on the panel 100 to maintain the relative position of the parts to be assembled according to their expansions by the movement of the pressing means 30 along the corresponding slide, while allowing a permanent monitored plastic deformation of the panel 100 against the form 20.

In one form, the pressure exerted in a range in the order of 6 Mpa to 18 Mpa.

Furthermore, the device 1 is at least partially of carbon-carbon material (in one for is the Sepcarb® brand material).

In another form, the elastic forcing means 210 are made of carbon-carbon material.

Such a material has low thermal inertia.

It is resistant at high temperatures and light, and thus reduces the mass of the device and can extend the service life of the device to about 20 years.

In a non-limiting example, the elastic forcing means 210 are formed by the methods described in French patent application FR 2 772 748, which is incorporated herein by reference in its entirety.

Furthermore, the device 1 allows a significant economic gain on the service life of an aircraft program on the investment as well as on the production time.

It also allows brazing several components at the same time as furnaces are limited in tonnage.

Its low mass also allows reducing the brazing cycle owing to the low thermal inertia of the tooling.

Furthermore, such a device may be placed in a brazing furnace provided with means designed to carry out a vacuum brazing.

A method of assembly by brazing using a device 1 according to the present disclosure is now described.

First, various points of attachment between the skins and acoustic structure of the panel 100, are carried out, preferably at each end of the jointing of one of the skins.

In a non-limiting example, these points may be welding points.

Thereafter, the panel to be brazed 100 is docked on the base 11 provided with the lower part of the form 20 (cut at the apex to allow its implementation and unmolding).

The panel 100 in place, it can then be installed the second part of the form 20 around the panel 100.

In a non-limiting example, six rings of 16 pads 32 are superimposed by a suitable system, facing the support structure 13 and independent from the latter.

These pad rings 32 are distributed radially opposite to an internal side of the panel 100 to be brazed.

Mounting of the expansion system 13 with the elastic forcing means 210 in the retracted position by the wedge systems 220 and 221, is then performed.

At this stage, the elastic forcing means 210 are compressed and biased by the withdrawal means 220 and 221. Once the expansion system 13 is locked by screwing on the upper part of the base 12, the wedge systems 220 to 223 may be removed to release the pressure from the pads 32.

At this stage, each deformation unit 200 exerts a pressure on the internal wall of the corresponding pad ring 32.

It is worth noting that the elastic forcing means 210 are in cold and hot compression throughout the brazing thermal cycle.

This allows preventing a detachment of the panel 100 with the tooling during the cooling phase of the cycle.

Furthermore, the compression of the panel 100 by the pressing means 30 is permanent, continuous and exerted before the beginning of the brazing cycle; during the whole brazing cycle until the withdrawal of the panel 100 from the form 20.

It is worth noting that, at room temperature (20° C.), the panel 100 to be brazed is not pressing on the form 20. Contact only occurs once the brazing temperature is reached.

Thus, prior to the brazing cycle, the locking means 220 are unlocked, the biasing of the elastic forcing means 210 is released for compressing each pad 32 on the panel 100.

In a following step, at least one brazing cycle is started after having emptied the furnace chamber.

The furnace temperature is thus raised to the brazing temperature.

During the rise in temperature, differential expansions between the elements of the panel 100 to be brazed, the filler material and the device 1 are present.

Each elastic forcing means 210 applied to the corresponding pressing means 30 causes the retainer rod 33 and the associated pad 32 in a displacement providing a pressure on the panel 100 such as to compensate the phenomena of differential expansion of the elements.

At the brazing temperature at the same time higher than the melting temperature of the filler metal and lower than the melting temperature of each of the three materials, the mechanical pressure exerted by each elastic forcing means 210 on the corresponding pressing means 30 is calibrated to move by sufficient axial stroke the related pressing means 30 to stretch the panel 100, so that it espouses the shape of the form 20.

The forces applied to the panel 100 extending beyond the forces related to the thermal expansion of the various elements thereof and providing to maintain these elements providing in contact throughout the brazing cycle, not only is the mechanical pressure applied adapted to form uniform braze joints for the brazed panel 100 but also to heat form the panel 100.

The following step consists in cooling the treated panel 100 by decreasing the temperature by suitable means, so as to solidify the filler metal which thus makes a connection between the two materials.

It is worth noting that, in one form, the brazing operation is carried out under vacuum.

At this stage, an acoustic panel 100 is obtained whereof the acoustic structure and the skins are brazed and the panel 100 conformed to its final shape.

Hence, a panel 100 brazed and conformed in one single operation with good brazing quality is obtained.

Thanks to the present disclosure, the differential expansions of the panel 100, the tooling and the filler material are monitored throughout the brazing cycle in order not to change the relative position of the latter and in a precise manner, the deformation of the panel 100 to a particular shape of a form 20 is guided, by a simple and rapid to implement mechanical device.

Such a device finds a non-limiting application in the brazing of panels 100 having to present one or several bends in their profile.

Advantageously, the geometry of the parts to be brazed and to be conformed can be a geometry of revolution.

Such a device allows reducing the brazing cycle time. In fact, the device 1 makes it possible to braze two pieces simultaneously since thanks to its low mass, it is possible to place two pieces in the same furnace. This can go as far as not needing to invest in a vacuum furnace.

Furthermore, it avoids problems of sealing that may occur in the assembly devices of the prior art where gas pressure is required.

It also reduces the phenomena of “telegraphing” resulting from a depression of the skins of the panels during their docking in the assembly devices of the prior art in which a gas pressure device is required

Such a tooling has an improved service life (no flow) and the maintenance, due to the simplicity of the device, is lesser and cheap.

Although the present disclosure has been described with specific form, it is obvious that it is in no way limiting and that it includes all technical equivalents of the means described as well as the combinations thereof if these fall within the scope of the present disclosure.

Thus, it can be considered to exert different or not local stress forces according to their position on the panel to be treated.

An alternative form may also provide to exert stress forces on either side of the panel 100 to be treated rather than on the same side of the latter.

Furthermore, an alternative form may provide a brazing cycle under a monitored atmosphere.

The present disclosure may also find a non-limiting application in brazing acoustic attenuation panels used in ejection cone/primary turbojet nozzle setups.

In addition, each panel may be conformed and brazed by a device according to the present disclosure with the front and rear flanges thereof welded with finished lugs. This provides the hold of the eject section and performing a thermal releasing treatment after the brazing while enjoying a hold of the setup throughout the cycle.

What is claimed is:

1. A setup for assembling a composite panel by brazing comprising at least two parts separated by a filler material and joined together by a braze joint, the setup comprising:
a furnace to reach a temperature for brazing the composite panel; and
an assembly device comprising a form having a shape similar to a final shape of the composite panel to be brazed,
wherein the assembly device further comprises:
pressing means to exert a mechanical pressure on at least part of a surface of said composite panel along a direction allowing to permanently deform the composite panel into a shape, a configuration of which complies with a configuration of the form, said pressing means being moved under an action of elastic forcing means, forces exerted by said elastic forcing means being determined so that, at the brazing temperature, said elastic forcing means exert the forces deforming the composite panel against the form.

2. The setup according to claim 1, wherein the forces exerted by said elastic forcing means are determined so that, throughout a thermal cycle, said elastic forcing means exert the forces for the deformation of the composite panel against the form.

3. The setup according to claim 1, wherein the pressing means are movably mounted in translation on a support structure by a sliding connection.

4. The setup according to claim 3, wherein the pressing means comprise at least one ring formed of a plurality of support pads distributed over the surface of the composite panel on which a mechanical pressure is exerted.

5. The setup according to claim 1, wherein the pressing means are provided with at least one travel stop.

6. The setup according to claim 3, wherein the pressing means are indexed on the support structure.

7. The setup according to claim 1, wherein the elastic forcing means comprise leaf springs and/or springs.

8. The setup according to claim 1, wherein the mechanical pressure exerted by each pressing means is defined independently from other pressing means.

9. The setup according to claim 1, wherein the elastic forcing means are each associated to a locking system defining a tensioning of the elastic forcing means.

10. The setup according to claim 12, wherein each locking system is a wedge system.

11. The setup according to claim 3, wherein the elastic forcing means are deformed in a direction of a slide.

12. The setup according to claim 1, wherein the assembly device is made of carbon-carbon material.

13. A method for assembling by brazing of a composite panel comprising at least two parts separated by a filler material and joined together by a braze joint implemented by the setup according to claim 1, wherein:
the composite panel is docked on a tooling device;
the assembly device is placed in heating means to achieve a brazing temperature of the composite panel; and
during a thermal cycle and at the brazing temperature, a pressure is exerted by the pressing means on at least part of the surface of said composite panel in a direction allowing to permanently deform the composite panel into a shape whereof the configuration of the composite panel conforms to the configuration of the form, the pressing means being moved under the action of elastic forcing means, the forces exerted by said elastic forcing means being determined so that, at the brazing temperature, said elastic forcing means exert the forces for the deformation of the composite panel against the form.
